(19) United States
(12) Patent Application Publication
(10) Pub. No.: US 2003/0026397 A1
(43) Pub. Date: Feb. 6, 2003

(54) System and method to facilitate commercial interaction over a communications network

(76) Inventor: Dennis McCroskey, Palo Alto, CA (US)

Correspondence Address: Dennis McCroskey, 1344 Emerson Street, Palo Alto, CA, 94301, US

(21) Appl. No.: 09/920,544

(22) Filed: Aug. 1, 2001

(51) Int. Cl. H04M 11/00

(52) U.S. Cl. 379/93.21; 379/90.01

(57) ABSTRACT

A commercial interaction system improves the convenience and efficiency of conducting a verbal interaction over a communications network (via telephone or Internet, with or without visual supplement). The interaction is conducted because one party (a “host”) is willing to provide and another party (a “guest) is interested in obtaining the value of the content communicated during the interaction. The present invention facilitates the scheduling, connecting, privacy management and convenient settlement of financial accounts necessary for the execution of said interaction.

An interaction is booked between a guest seeking verbal (or verbal and visual) access to a host who wishes to provide said access. The system allows the two parties to conveniently establish a mutually acceptable time for the interaction. The interaction is automatically initiated by a communications sub-system at the agreed-upon time. Since the interaction is not directly between the parties, privacy is maintained with respect to certain data (such as place, telephone number and other identifying data) that may be communicated as part of a telephone interaction. Information regarding the interaction (such as duration, time of day, etc.) is returned to the database to facilitate efficient payment or settling of accounts between the parties.

### FIELD OF INVENTION

The present invention addresses the problem of the high cost and inefficiency of multiple parties' interacting verbally (or verbally with visual assist) for commercial purposes over a communications network.

### BACKGROUND OF THE INVENTION

The present invention addresses the problem of the high cost and inefficiency of multiple parties interacting verbally (or verbally with visual assist) for commercial purposes over a communications network, such as a telephone system. Specifically, these interactions are often impractical, because of the prohibitive cost, time requirements, and frustration related to:

a) Scheduling an interaction among two or more parties;

b) Establishing an interaction among two or more parties;

c) Controlling the flow of identifying information among two or more parties;

d) Recording and storing information describing the communications interaction among two or more parties; and/or

e) Financially settling accounts among the parties, once the interaction is complete.

Since the emergence of verbal, commercial interactions (for example, a patient consulting a doctor, a client consulting a lawyer, or an individual seeking computer related advice), it has been impractical to conduct many such interactions when their value or duration fell below a certain threshold or when, due to the physical separation of the parties, the parties could not conveniently organize a face to face encounter. At some point, the scheduling, execution and financial settlement of such an interaction can exceed the value of the interaction itself For example, it might be difficult to engage an attorney for a one-hour consultation, since scheduling a time for the consultation may take several telephone calls over several days, travel to a mutually convenient location for the consultation is prohibitively expensive or the billing and payment process (or collection if payment is not prompt) may take more time than the consultation itself.

As society becomes increasingly comfortable communicating through electronic and other non-face-to-face means, it has become clear that many interactions could occur over the telephone (for example, a computer owner seeking advice from a computer expert). However, the scheduling, execution and financial settlement issues remain daunting today. For example, if a computer expert offers telephonic advice, someone seeking that advice is still faced with the issues of scheduling an interaction (which scheduling might require several interactions itself), initiating the interaction (which may mean sharing information such as private telephone numbers and initiating a phone call) and billing (which may require giving credit card information to the computer support expert, or an address for billing).

Another issue raised by the emergence of telephone interaction is the fact that interactions no longer need be local. For example, a patient can consult via telephone with a doctor many thousands of miles away. The ability to interact over long-distances vastly increased the number of possible interactions, but also makes the task of identifying, evaluating and selecting parties with whom to interact more daunting. This ability has also lead to a need for anonymity: many parties interacting over long-distances are unknown to each other, and may wish to interact while maintaining privacy of their personal telephone or billing information.

With the evolution of the Internet and advances in communications systems, some interesting, but insufficient elements, have emerged that address various narrow aspects of the problems identified in the preceding paragraphs. For example, Internet directory companies such as Keen.com make finding some types of experts easier on a national or even global level. The “1-900” telephone numbers provide simple billing, but only for one payment method and only for unscheduled interactions. These elements are quite insufficient, and do not make possible wide adoption of commercial conveyance of valuable information over a communications network via verbal or verbal and visual means. More specifically, an individual or business wishing to engage in a commercial interaction to convey valuable information over a communications network is currently forced to (a) directly negotiate the scheduling of and financial settlement with respect the interaction, or (b) use a 1-900 toll number, or (c) use a web site which offers “expert matching”. All of these methods are inadequate in making interactions of valuable information viable, as described more particularly below:

### Scheduling and Billing Deficiencies

Scheduling a telephone interaction for commercial purposes has been quite inefficient, given the time requirements and logistical complexities necessary to set up a call and settle payment for the interaction. Often these logistics of arranging a call (for example, to speak with a doctor for 15 minutes about a drug interaction) take longer than the actual call itself. One issue is that for two parties to establish a mutually agreeable time to speak, they must often call or e-mail each other until they both are available to discuss when they will be available for a formal interaction in the future. Once they do reach each other, they must coordinate their various commitments and schedules verbally or through a series of e-mails. In addition to the amount of time required to arrange an interaction time, the parties must provide each other telephone numbers or e-mail addresses that one or both parties may want to keep private. Yet another issue is the great variation in the quality and responsiveness of the scheduling abilities of various parties. While one party may quickly and efficiently respond to a request using his/her own automated calendar system, another party may have no such ability.

With respect to billing, telephone interactions are of a short enough duration and small enough value that they may not justify complicated billing and collection procedures. For example, the combined cost of the time required to generate a bill, mail it, and follow-up on its collection may be nearly as expensive as the interaction itself Credit card interactions can also require significant upfront investment in equipment, paperwork, and other expenses. Furthermore, these billing methods between two parties do not provide for confidentiality with respect to billing information (for example, a person would have to provide his credit card information directly to a party with whom he wanted to interact or would have to provide an address for billing).

### 900 Number Deficiencies

Buyers are reluctant to use “1-900” or “pay-per-call” numbers (Benyacar, et al. U.S. Pat. No. 5,003,584 and Haralambopoulos, et. al. U.S. Pat. No. 5,148,474), as they have a “less-than-serious” stigma; do not allow an individual to keep his telephone number private; do not provide the ability to pre-schedule an interaction with a selected counter-party and do not allow for negotiated billing. In fact, a recent FTC report (“The Federal Communications Commission In the Matter of Policies and Rules Governing Interstate Pay-Per-Call Services and Other Information Services Pursuant to the Telecommunications Act of 1996 and Policies and Rules Implementing the Telephone Disclosure and Dispute Resolution Act Comment of the Federal Trade Commission”, Oct. 30, 1996) indicated that “1-900” number usage has declined precipitously since the mid 1990s due specifically to the abuses which these systems lent themselves to (no visibility to charges; recorded messages which took too long to convey advertised information, etc.). Accordingly, they are restricted to applications which are not considered substantial, and where the need to interact directly among two parties (as opposed to one party merely receiving static information) is of minimal importance. Hence, most “1-900” applications are used for selling pre-recorded messages.

### Expert Matching Deficiencies

In the case of “expert matching” applications (for example, Lauffer, et al., U.S. Pat. No. 6,223,165) the basic functionality focuses on the “rapid selection and connection” with experts. In particular, these systems purport to add value by decreasing the time required to find an appropriate expert and by increasing the quality of the fit between the expert and individual. While a telephone interaction may result from this system—once an appropriate match is made—the Lauffer application makes no reference to the convenience of scheduling, the anonymous initiation of the interaction, or the quantification of the interaction for financial settlement among the parties.

With respect to scheduling capability: the number of parties who can connect “immediately” or “within an hour” (the primary value described in Lauffer) is, by definition, dramatically smaller than the number of parties who can connect immediately as well as in the future. Thus the technique of Lauffer is less than desirable because it only discloses the ability to connect immediately.

With respect to the central matching process: there is an abundance of existing services that provide matching or referral tools that parties may wish to use to find one another. The “Yellow Pages”, the parties' own web sites, or highly focused web directories (say, focusing on computer applications) are examples of these. Systems which prefer that users rely upon a central directory provided by the invention itself are deficient. Specifically, by utilizing a centralized directory, Lauffer's invention undermines the value of the many highly developed, third party matching systems. For example, a national lawyers' association might have a more complete and detailed directory of attorneys, than might be found in a generalized directory. Thus, the technique of Lauffer is less than desirable because it forces users into a central directory that is likely of inferior quality to many third-party directories.

### Other Systems' Deficiencies

Some applications provide versions of a “busy signal/callback” method (for example, Jain, et al. U.S. Pat. No. 5,742,674, Click121 website). These applications essentially allow a user who receives a “busy” signal or automated message the option of receiving a call back at a later time. These applications do not allow for negotiation of an acceptable time among the parties, and do not provide anonymity with respect to privacy information (e.g., the number of the calling party). Accordingly, the value of such applications is greatly diminished compared to the presently described invention.

Some applications describe methods to automatically connect two parties, but generally do so for the sole purpose of arbitraging telephone rates (Dorst, et al. U.S. Pat. No. 4,969,185; Nielsen U.S. Pat. No. 6,212,268), and make no mention of the ability of one party to provide value to the other. Further these applications do not provide anonymity, and do not provide for quantification of the interaction.

Some applications describe methods for a “reminder” system (Mainker; Praful U.S. Pat. No. 5,909,487) wherein a call is booked in advance so the individual does not have to separately track and initiate the telephone call. An example contemplated in Mainker describes an upcoming birthday in which one party wants the call to be initiated on a specific date so that a birthday is not forgotten. Applications like Mainker do not consider that information conveyed during the call is itself of commercial value, and therefore make no accommodations required for a commercial interaction to take place.

Some applications describe methods for providing anonymity. For example, Solomon, et al. (U.S. Pat. No. 5,058,152) suggests a method for directly connecting two parties via a code that strips out all identifying information. These methods that provide anonymity are deficient because they do not allow for the critical elements of scheduling, quantification or financial settlement for the telephone interaction. Further, they do not contemplate the situation in which one party provides value to another.

### Conclusion

There is a significant lack of, and need for, a system and methodology that allows multiple parties to connect over a computer for the purposes of providing and receiving valuable content through verbal (or verbal and visual) exchange over a computer and a communications network. Such an interaction is made virtually impractical, by the lack of an integrated system to schedule, initiate and provide settlement for an interaction between two parties. Present art provides an insufficient and disparate set of tools, none of which alone or in combination provides the elements to make viable vast number of interactions that could take place should such a system exist.

### BRIEF SUMMARY OF THE INVENTION

The present invention provides a method and system that makes verbal (or verbal and visual) interaction over a communications network practical for purposes of conducting commerce. It facilitates interaction wherein one party (a “host”) seeks to provide, and a second party or multiple parties (a “guest”) (collectively “parties”) seeks to receive valuable content. It makes such interaction for commercial purposes practical by providing the means to conveniently schedule, automatically initiate, and anonymously conduct the interaction over a communications network, such as a telephone network. Anonymous conduct is defined as an interaction where each party is not provided with the other's contact information. The invention further facilitates such commercial interaction by providing a convenient method for quantifying the interaction for purposes of settling financial accounts among the parties.

With the present invention, a host can conveniently provide data regarding the terms upon which he or she will interact (e.g., the time, duration and cost of the interaction), as well as information about the valuable content he or she might provide (e.g., legal advice, tutoring, technical support, etc.). The guest is provided a convenient method to access the host's data, and is further provided a convenient method for requesting and confirming an interaction time and duration. Once the interaction is confirmed, a communications subsystem, at the appointed time, initiates the interaction among the guest and host over a communications network. The connection established by the telecommunications network protects the privacy of the two individuals with respect to data that may be transmitted by the network, such as location information, telephone number, etc. The communications network tracks information about the interaction (such as the duration of the interaction, time of day, date, etc.) and sends it back to the computer system when the interaction is completed. The information is then conveniently made available to the host and the guest for settling their financial accounts.

The invention has a number of advantages. The scheduling capability substantially expands the possibility of two parties' finding an agreeable time to interact, thereby increasing the number of possible interactions. It endows the invention with substantially more utility than one that strives to match parties immediately. The scheduling capability also drastically reduces the time, cost and frustration of arranging a mutually acceptable time for two parties to meet.

The invention initiates the call among the two parties, freeing the parties from the need to track each other's telephone information, and retaining the privacy of such information.

The invention facilitates financial settlement among parties, while simultaneously maintaining anonymity with respect to telephone number, home address or credit card information. These data are elements that many people wish to maintain as private. Further, billing and collecting are beyond the capabilities or resource constraints of many potential hosts.

The invention frees the parties from a need to use a particular matching system or directory thereby increasing the value it provides. That is, it may be adapted to support any directory of hosts or guests, not just a directory contemplated by the present inventor.

In summary, this method facilitates commerce over a telecommunications network. It does so by greatly reducing the risk, uncertainty, time and complexity related to the scheduling of, conducting and settling of financial accounts for an interaction.

### BRIEF DESCRIPTION OF THE VIEWS OF THE DRAWING

FIG. 1 shows a block diagram of the components comprising the commercial interaction system

FIG. 2 shows the database elements utilized in the commercial interaction system

FIG. 3 shows a block diagram of the components comprising the communications subsystem of the commercial interaction system

FIG. 4 shows a block diagram of the components comprising the financial settlement subsystem of the commercial interaction system

FIG. 5a shows a flowchart describing the process of the commercial interaction system

FIG. 5b shows a flowchart describing the process of the communications subsystem

FIG. 5c shows a flowchart describing the process of the financial settlement subsystem

### DETAILED DESCRIPTION OF THE INVENTION

### Definitions

Scheduling: The process of arriving at a mutually desirable time for two parties to interact. For example, one party might state times she is available, and the second party might choose among those times. Another example is that the parties suggest times to one another which are either confirmed or rejected.

Identifying information: Any information about an individual or business that wishes to interact with others. Information such as (but not limited to): name, location, services provided, services sought, telephone number, financial information for billing, etc.

Anonymous: Void of “any identifying information,” such as phone numbers or email addresses.

Quantifying: In this context, recording characteristics such as interaction time, duration and cost per unit of duration for purposes of establishing the value of the interaction, whether such value is billed among the parties or not.

Valuable Content: Any information that one or both parties deem to be of economic value, conveyed by verbal or verbal and visual means. For example, a doctor providing advice would be providing valuable content.

Interaction: The session during which valuable content is exchanged or conveyed from one party to the other.

Internet: A collection of interconnected (public and/or private) networks that are linked together by a set of standard protocols (such as TCP/IP and HTTP) to form a global, distributed network. (While this term is intended to refer to what is now commonly known as the Internet, it is also intended to encompass variations which may be made in the future, including changes and additions to existing standard protocols.)

Interface: Any mechanism by which an external individual or external computer can obtain and provide data, respectively to or from the database of the present invention. One common example of the interface is a web site. Other examples might include an e-mail message, a telephone voice message, or a paper report.

Web Site. A computer system that serves informational content over a network using the standard protocols of the World Wide Web. As used herein, the term is generally intended to encompass both (i) the hardware/software server components that serve the informational content over the network, and (ii) the “back end” hardware/software components, including any non-standard or specialized components, that interact with the server components to perform services for Web site users.

Guest: A party or parties who wishes to receive valuable content

Host: A party or parties who wishes to provide valuable content.

### Overview of the Commercial Interaction System

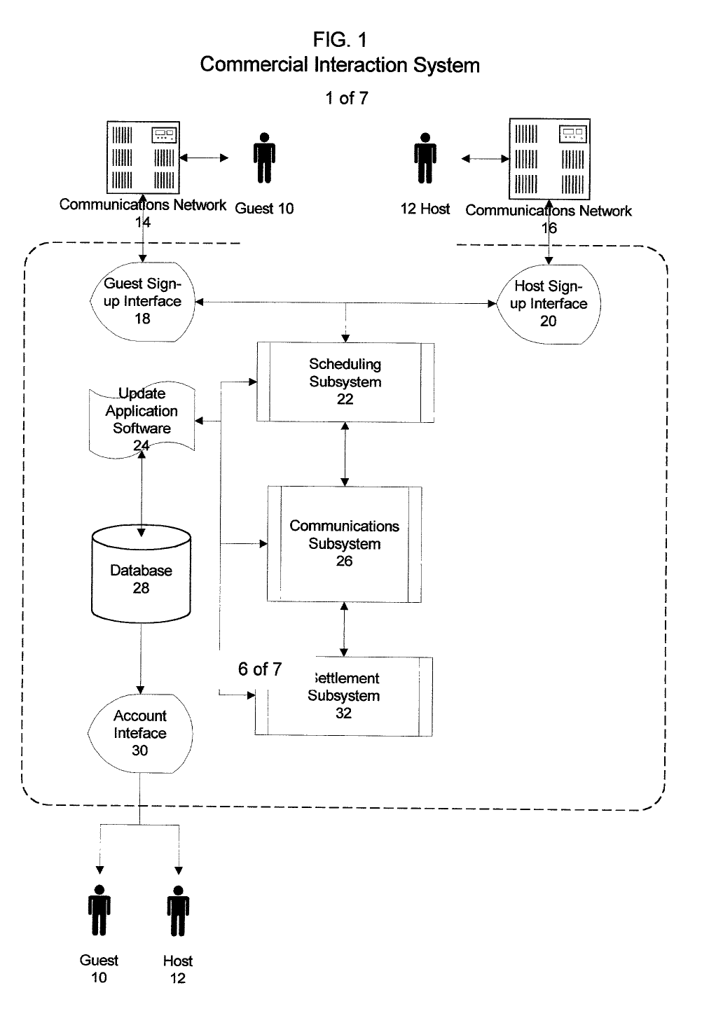

FIG. 1 illustrates the general architecture of a system that operates in accordance with the present invention. A guest 10 is connected to the present invention via a communications network 14. A host is connected to the present invention via the same or a separate communications network 16. Either communications network might be the Internet, a telecom system, a wireless telecom system or any other system used to communicate data.

A guest sign-up interface 18 and a host sign-up interface 20 provide means for collecting identifying information about the guest and host, respectively. For example, either interface might be a web-based form into which the guest enters data by filling out individual fields. Either interface might also be a telephone-based system, wherein the data is recorded by a real person, a voice recognition system, or an interactive telephone system (where data is entered via a telephone keypad).

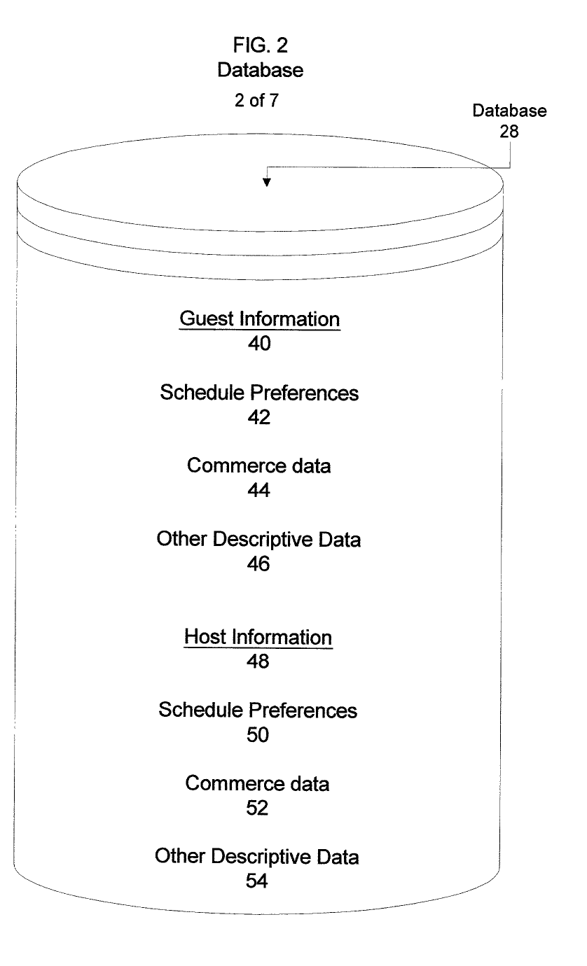

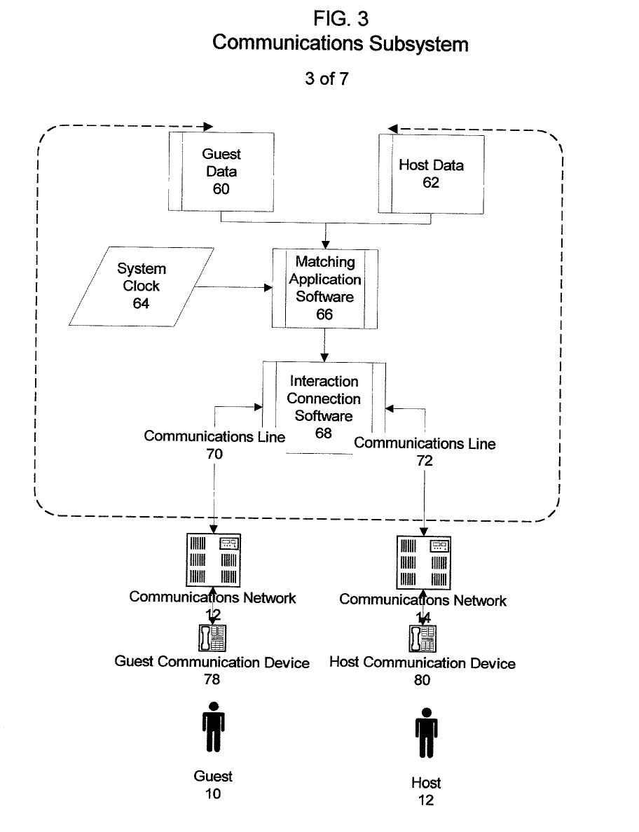

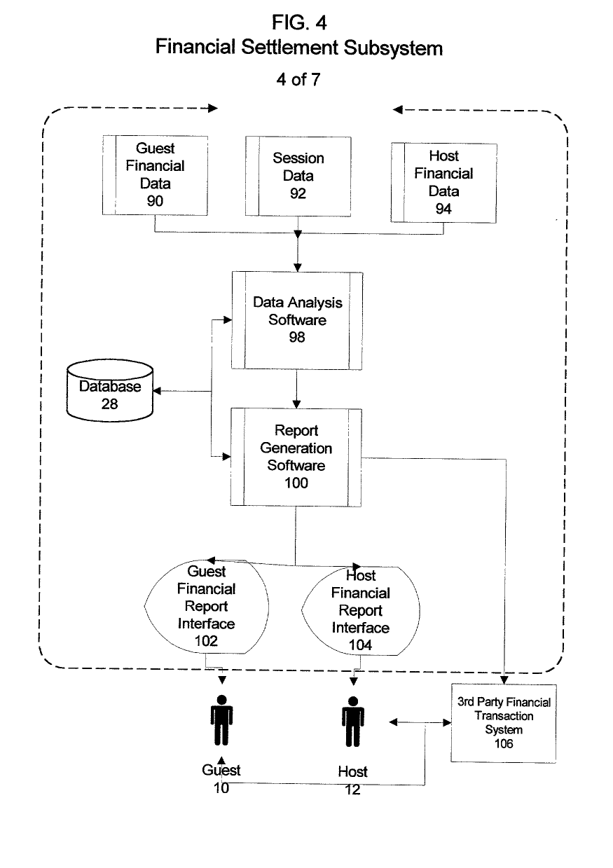

A scheduling subsystem 22 is connected to the guest sign-up interface 18 and the host sign-up interface 20. The scheduling system may be a third-party system. It may be a simple or complex scheduling system. For example it may be a simple computer algorithm that connects the host and guest when each indicates she is “available now”. Or, it may be a complex system in which, for example, parties bid for each others' time, or in which their schedules are blind to one another until a match is made. The scheduling subsystem is connected to an update application software 24 which in turn is connected to a database 28. The update application software 24 also connects the communications subsystem and the settlement sub-system to the database. The database is more completely described in FIG. 2, the communications subsystem is more completely described in FIG. 3 and the financial settlement subsystem is more completely described in FIG. 4.

An account interface 30 connects the information stored by the database 28 to the guest 10 and/or host 12. The interface may take any form that the host or guest finds convenient. For example, the account interface may be a web page that presents data, or it may be a recorded telephone message, or it might be a live person conveying the information, or it may be a printed report.

FIG. 2 shows the database and describes the type of information the database collects and maintains. Guest information 40 and host information 48 are collected and maintained by the database.

Guest schedule information 42 may be information related to the times and dates when the individual is available to—or prefers to—interact. It might include specific blocks of time (e.g., “Tuesday, 9 am-12 pm”) or more general time preferences (e.g., “weekday mornings”).

Commerce information for the guest 44 is information that is required or preferred by the guest for the settling of the guest's financial accounts. Guest information 44 might include credit card data, bank account data, address data, and other verifying information (such as social security number or credit history).

Other descriptive data regarding the guest 46 includes any data that might be relevant to conducting commerce with a host over a communications network. This descriptive data may include information about the guest's history of interactions with hosts. It might also include other information used to match the individual with hosts. For example, the descriptive data might include pricing preferences or preferences regarding types of hosts with whom the guest might want to interact (for example, a preference for professionals such as doctors as opposed to entertainers such as musicians). It might also include information regarding the reliability of the guest in conducting or paying for previous interactions with hosts.

Host schedule data 50 describe the dates and times during which the host is available to interact. For example, this data might be a list of blocks of times when the host is available to interact. It may be blocks of time that have been confirmed for a scheduled interaction—that is, which has been selected by the guest from the host schedule. In another example, the data might be less specific preferences, such as “weekday mornings”.

Host commerce information 52 may be similar to the guest commerce information 44, or it may include additional or different information. For example, it might include data about the affiliation of the host. If the host is an employee of a company, then banking and credit card information about the company might be collected and maintained. If the host is a member of a group (for example, a professional association), commerce information with respect to that group might be maintained.

Other descriptive data regarding the host 54 includes any data that might be relevant to conducting commerce with that host over a communications network. This descriptive data may include information about the history of interactions with guests. It might also include other information used to match hosts with guests. For example, the descriptive data might include pricing preferences or preferences regarding types of guests with whom the host might want to interact (for example, a preference for guests who are students of architecture, or a preference for adult or mature guests). This host descriptive data might also include data that validates the valuable information he provides. For example, it might include information regarding the number of times the host has failed to keep an appointment for an interaction with a guest.

FIG. 3 shows a block diagram of a communications subsystem. The communications subsystem comprises a data storage component for guest data 60 and a data storage component for the host data 62. These data storage components may be a subset of the database (FIG. 2) or may be a separate database connected to the main database of FIG. 2. A matching software application 66 connects the system clock 64 to the host data 62 and guest data 60. The matching application determines when the time for an interaction has been reached and is capable of communicating an initiation command to the communications subsystem 68 (described further in FIG. 4). The matching application may be an automated application that determines the interaction time based on the guest and hosts preferences, or it may have more complex criteria. For example, it might match a guest with the soonest available host. The system clock 64 is a clock which tracks the actual date and time of day and may be accessed by the matching application software 66. The matching application software 66 is linked to interaction connection software 68. This interaction connection software 68 is capable of initiating communications via at least two separate communications lines (70,72) and bridging a connection to link those two lines. The software is also capable of presenting to the host and the guest prompts (instructions) and is further capable of receiving and interpreting the responses from those prompts. For example, the system might first connect the host via telephone and play a pre-recorded prompt stating “please press 1 if you wish to be connected to your guest”. It might then connect the guest and repeat a similar process with the guest to complete the connection.

The communications lines connect via a communications network(s) (12, 14) to communication devices (78, 80). The host and guest might be reached via similar or different communications networks. The communications network might, for example, be the Internet or a telecom system. The communications devices used by host and guest might be similar or different. The communications devices might, for example, be telephones, wireless telephones, or computers which have been adapted to transmit voice.

FIG. 4 shows a block diagram of a financial settlement subsystem. A subset of the database containing guest financial data 90, host financial data 94, and session data 92 are connected to a data analysis software 98. Guest financial data or host financial data might include credit card, banking or other billing information. Session data would include any information relevant to settling the accounts between the two parties. For example, it might include the rate per unit of time agreed upon for the interaction, as well as the amount of time actually required by the interaction.

The data analysis software is capable of generating a billing amount from the information provided it. It is connected to a database 28 which may store this information. It is also connected to a report generation software 100 which is capable of creating a report regarding the financial settlement among the host and guest. For example, this report might include information about the amount due, the rate per unit of time, the units of time used, and any discounts, if relevant.

The report generation software may be connected to an external financial settlement system 106, which is capable of debiting and crediting financial accounts.

The report generation software is also connected to a guest report interface 102 and a host report interface 104. The interfaces, for example, may be web pages, verbal reports, or printed reports. For example, a monthly report might be generated, printed and mailed to both host and guest.

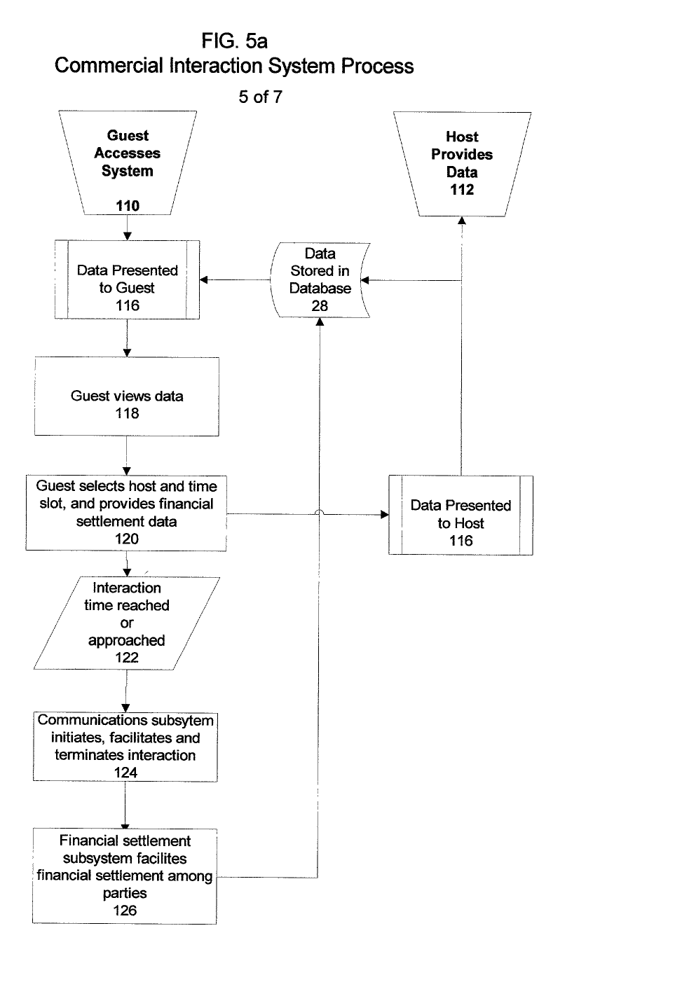

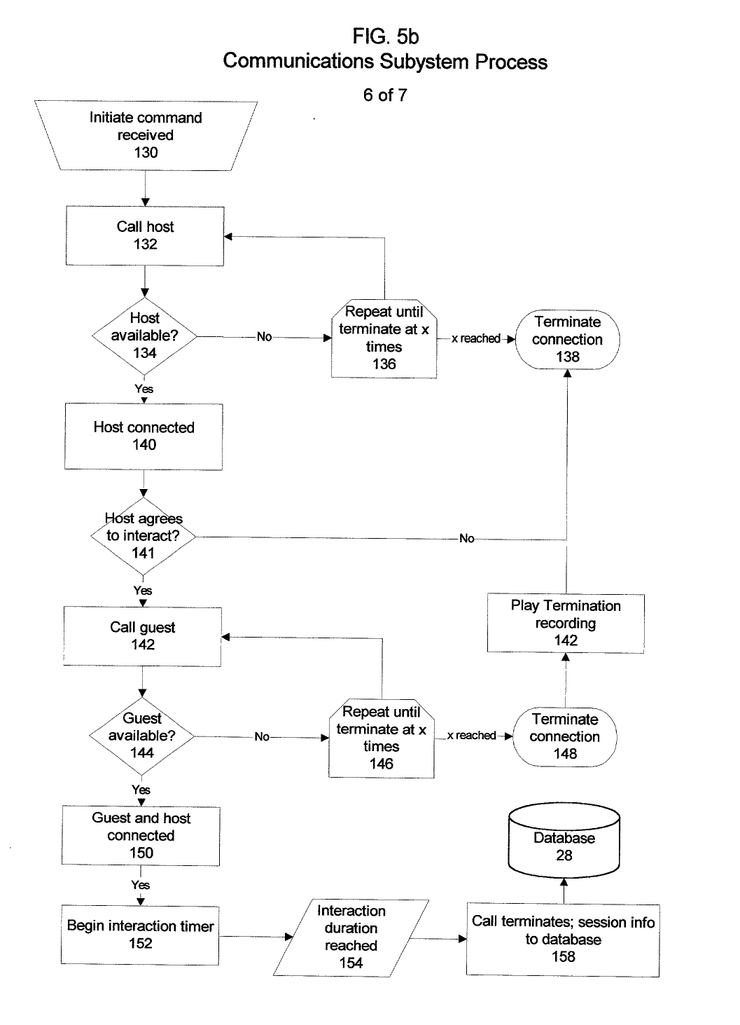

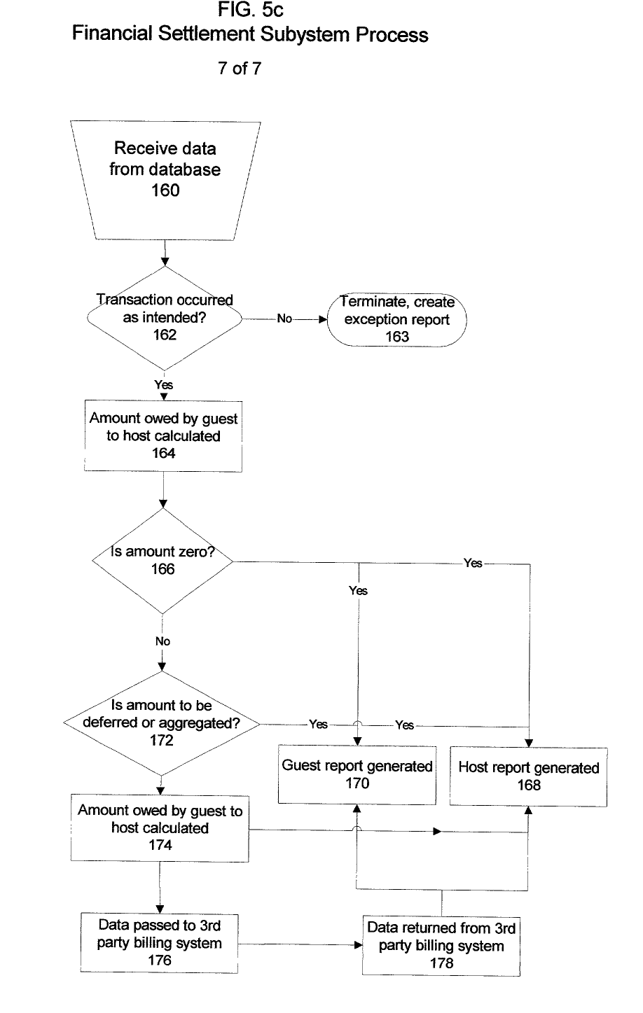

### Operation of Commercial Interaction System: FIGS. 5a, 5b and 5c

The process begins with a host providing data 112 regarding the terms upon which she is willing to interact with a guest. The data would include: the nature of the host or host's business, the rate the host charges to interact, and the schedule of availability that the host is willing to provide. For example, a lawyer might provide data indicating the type of law she practices, the time of week she is available (say, Monday from 8 am to 11 am), the rate she charges to interact (say, $3 per minute), and the minimum amount of time she wishes to spend on any given interaction (say, 5 minutes). The host also provides data that may be used by the financial settlement subsystem and the communications subsystem to execute their respective processes. Financial settlement data would include banking, credit card or other relevant information required to credit the financial accounts of the host. Communications data would include a telephone number or any other identifying information required to initiate communication with the host including an optional security code or password the host may choose to enter.

The host can provide data in several ways. He or she can enter it directly into the present system's database 28 via an electronic interface (for example, a web page where she can type in her data). Data can also be transferred automatically from an existing database, which contains the relevant information about the host. For example, a law firm wishing to have its attorneys made available via the present invention might already have a database containing the information required by the present invention for each of its attorneys. The firm could electronically transmit an electronic file containing data about the nature of each of its lawyers specialty, and a telephone number at which each could be contacted, etc. The electronic data could be added to the database 28 by the operator. Since, in this example, the law firm itself would receive financial payment, only a single bank account would be required for multiple hosts.

Once the host's non-anonymous data has been stored in the database 28, it is made available for viewing by the guest. The data is presented to the guest 116 in any way that makes it convenient for the guest to understand the nature of the host, and the terms upon which the host will interact. For example, the data may be presented on a web page that the guest can access via the Internet. The data might also be made available over the telephone, and be accessed by the guest over a telecommunications network. The data might also be provided via the host's own web site or a third-party web site that aggregates individual hosts. Specifically, in this instance, the guest may view the data 118 either at an interface provided by the present invention, or a separate interface provided by the host itself or an aggregator of hosts. For example, an education-focused directory might list individual tutors by subject. Guests seeking hosts who are tutors might use the third-party web site to identify one with whom they wish to interact, and via an HTML link be immediately connected to the present invention. In this example it can be seen that the present invention does not diminish—but is complementary to—the valuable information that is often presented by hosts themselves or by third-party aggregators of hosts (e.g., web directories).

Next, the guest acts upon the data provided 120. The guest views the hosts' availability and selects a time and duration for interaction. If the host is available immediately, and the guest wishes to interact immediately, then the interaction time is considered “reached” 122 and the communications subsystem process is initiated. If the guest selects a future available time of the host, then the time and duration of the interaction are recorded in the database 28 and queried repeatedly 122 until the interaction time is reached. Once the guest selects a future available time for the host, that block covering that time is added to the list of available times presented to other guests. Further, the scheduled interaction time and duration established by the guest's selection is immediately made available to the host for viewing. The host may view it via a web interface which he accesses via the Internet, or may receive an instantaneous e-mail about the schedule or may receive written or telephonic notification.

In some cases, in order for the communications subsystem to initiate and interaction between the guest and host, the communications subsystem may verify that the guest has, in addition to other information pertinent to the proposed interaction such as an accessible phone number, entered appropriate billing information such as a credit card number and expiration date. Furthermore, the communications subsystem may before initiating the interaction between guest and host seek confirmation that the financial settlement subsystem described in FIG. 5c has received authorization to charge the guest's credit card as well as validation as best as can be determined that the card is not being used in a fraudulent manner.

As the time for the interaction approaches 122 a subroutine instructs a communications subsystem 124 to initiate the interaction. The communications subsystem is shown in FIG. 5b. The communications subsystem process begins by calling the host at the provided “number” (or whatever identifying information is used to alert the communications device to in turn notify the host that he has a call). If the host does not “answer” 134 (that is, does not engage the communications device), the communications subsystem re-calls the host 132 until the host is available. After a set number of times where the host is not available, further attempts to contact the host are terminated.

When the host answers the communication device 140, the communications subsystem may or may not prompt the host to enter a pre-selected security code, depending on the level of security the host has earlier selected. Entry of the correct security code enables the communications subsystem to verify that the host is the same person who earlier submitted his information and schedule to the communications subsystem because, in theory, even if the communication subsystem has reached the provided “number,” a different party if present might answer. Then, the host is asked to indicate whether he is ready to interact with the guest. (For example, if the connection has been made via a traditional telephone system, a voice prompt might say, “please press ‘1’, if you are ready to be connected to your guest”: pressing 1 would initiate the next step of the process, calling the guest.) The host then makes his choice to interact or not 141. If the host does not choose to interact, the communication subsystem process concludes, or concludes after the guest is notified of the host's decision not to interact.

If the host chooses to interact, the communications subsystem next calls the guest 142 at the provided “number” (or whatever identifying information is used to alert the communications device to in turn notify the guest that he has a call). If the guest does not “answer” 144 (that is, does not engage the communications device), the communications subsystem re-calls the guest 145 until the guest is available. After a set number of times where the guest is not available, further attempts to contact the guest are terminated 148 and the host connection is terminated as well. A termination message 142 would then be presented to the host. For example, a recorded message might state “we're sorry, but the guest is not available at this time. Goodbye.”.

If the guest is available 144 the communications subsystem may or may not prompt the guest to enter a pre-selected security code, depending on the level of security the guest has earlier selected. Entry of the correct security code enables the communications subsystem to verify that the guest is the same person who earlier submitted his information and schedule to the communications subsystem because, in theory, even if the communication subsystem has reached the provided “number,” a different party if present might answer. If the guest has not selected a security code or enters the correct security code, she is connected 150 to the host. At this point, both lines are connected by the subsystem, which bridges the two lines together. While the bridging may take many forms (two separate lines may be connected, a single line may connect the two parties, etc.) identifying data (such as the host or guest phone number; host and guest area code, etc.) are not passed from host to guest, unless they so request.

When the call initiates, an interaction timer 152 is also initiated. Once the interaction duration previously established (if any) is reached 154 the call may be automatically terminated 158 or the guest and host may be notified that the duration time has been reached. For example, if a guest and host had scheduled a twenty-minute call, a message at eighteen minutes might say “this call will be terminated in two minutes”, and at the twenty-minute mark both calls would be terminated. Alternatively, in this example, at eighteen minutes the guest and host might hear a message that said “this is a warning that you are about to reach the agreed-upon time of twenty minutes in two minutes”, but the system would not automatically disconnect the guest and host. It is also possible that neither the individual nor the host has set the duration for the interaction, and the call would be terminated only at the discretion of the guest or host or both.

Once the interaction is terminated 158 the communications subsystem returns information about the session to the database 28. Such information might include: the duration of the call, the locations of the host and guest, telecom toll charges, time of day the call occurred or any other information that might be relevant to financial settlement among the parties.

FIG. 5c describes the financial settlement subsystem process. Relevant data is accessed 160 from the database. Such relevant data might include: the price which the guest and host agreed upon per unit of interaction; the duration of the interaction; the status of the interaction (completed successfully, incomplete, etc.) the time the interaction began, the time the interaction terminated, etc.

The various data are reconciled 162 to determine if each scheduled interaction has occurred as intended. A subroutine would first determine all of the interactions that were scheduled, and compare that data to the transaction data reported by the database. If the interaction did not occur, or was incomplete, an exception report is sent to the system operator 163 for further action. As an example, a software program might run daily to access all of the interactions that were scheduled to occur, and then compare that data to the actual interaction data. Data regarding any interaction that completed successfully would be forwarded to the next stage of the process 164.

If the amount determined to be owed by guest to host is zero, then host and guest reports are immediately generated. These reports are described in detail later. There are multiple reasons the cost of financial settlement might be zero. In one case, the host (not the guest) might be paying for the interaction. For example, a software company may use the present invention to offer scheduled technical advice on its products. In this case, the host might pay a monthly fee for use of the invention and would not charge the guest. Alternately, the duration of the call may have fallen below a certain threshold. For example, a host might offer a guest a “free trial”, where the first five minutes of conversation is free, and the guest pays thereafter.

If payment is owed to the host from the guest, the amount is calculated 174. Many payment methods are possible. Payment may be a per-minute rate (for example, $1.00 per minute); or it may be a percentage of the value of the transaction (for example, 30% of the host's fee for her time); or a recurring fixed rate (for example, five hundred minutes a month for $500, whether the minutes are used or not). Variations of all of these payment methods are also possible. For example, one rate might exist for early usage, and another rate for later usage. Or, there may be an initial set-up fee, followed by ongoing interaction fees.

Once the amount owed is calculated 174, a third-party billing system is provided with the data it requires, and the account of the host is credited while the account of the guest is debited. Any billing system (manual or automatic) and any form of accounts (bank, checking, credit card, etc.) may be integrated with the present invention.

Next, a report is generated for the guest 170 and a report is generated for the host 168. Such reports would include information about the financial settlement among the host and guest. If no further settlement is necessary, such information might also be presented in the report. The data presented to the host and/or guest might include: the price which the guest and host agreed upon per unit of interaction; the duration of the interaction; the status of the interaction (completed successfully, incomplete, etc.); the date of the interaction; the time the interaction began, the time the interaction terminated, the financial settlement amount calculated, the results of the financial settlement etc.

The process described herein can be implemented using any programming language based on the steps disclosed herein, assuming familiarity with electronic data and telecommunications.

### Conclusions, Ramifications and Scope

From the description above, a number of advantages of the present invention become evident. Commercial interactions that were not possible prior to this invention become practical with its introduction.

The prohibitive cost, time and frustration of scheduling an interaction over a communications network are greatly reduced. The prohibitive cost, time and frustration of negotiating the price of an interaction are greatly reduced by the invention's ability to present relevant data, schedule and settle financially among the parties. The confusion of determining who must initiate an interaction, as well as the confusion of maintaining the information needed to initiate the interaction is eliminated by the invention. Security concerns regarding the transmission of personal telephone information are removed, since the invention prevents the transmission of data that would otherwise be transmitted in a person-person interaction. The automatic recording and storage of metrics regarding the interaction and the automated financial settlement system of the present invention greatly reduce the cost, time and frustration of settling accounts among the parties.

Users who will benefit from the present invention may take multiple forms and may put the invention to many, varied uses.

Users may be individuals (for example, a college student who earns extra money by using the present invention to provide computer repair advice). Users may also be organizations such as a company that directly employs hosts, or organizations that aggregate hosts. For example, a law firm might use the present system to earn additional money from the lawyers it employs. A similar goal might be achieved by a co-op of individuals who have organized for marketing purposes. For example, an organization of tax experts specializing in income tax work might provide advice at tax-filing time.

Applications of this invention may occur in many areas, such as entertainment, leisure, business, education and government. For example, in the area of entertainment and leisure, public figures (sports stars, movie stars, psychics, etc.) might use the present invention to generate additional income by charging fans for the opportunity to speak with them. In the leisure category, for example, professional coaches might offer their services as “long-distance coaches” who provide training advice to amateur athletes via the telephone.

Members of a number of professional occupations may also benefit from the present invention. Lawyers, computer specialists, and others who offer specialized technical advice might do so via the present invention. Doctors or nurses might use the present invention as a more efficient mechanism to schedule follow-up telephone calls with patients to discuss lab results, symptoms, or treatment options when it is not essential to meet face to face. Counselors and psychologists might use the present invention to schedule, execute and bill for certain counseling sessions, greatly reducing the hassle and time requirement of the counselee (scheduling, physically arriving at the appointment, billing, etc.).

Businesses may use the present invention to greatly improve the efficiency of—or even introduce for the first time—customer support capability for their business. For example, a small software firm with only two engineers might use the present invention to avoid staffing a “call center” and hiring a full-time technical support employee. Rather, the firm could use the present invention to make those engineers available to the firm's customers for a limited time each week. The engineers might answer technical questions during these sessions, but would be able to focus on their other development work the rest of the week.

Individuals, businesses and organizations involved in education may also benefit from the present invention. The present invention can be used to facilitate rapidly the scheduling, execution and billing of long-distance tutoring sessions, for example. College professors or adult education instructors might use the present system to reduce the hassles of scheduling and of being available for office hours. K-12 teachers might use the present invention to reduce radically the complexity and time of conducting parent-teacher interactions.

Elected government officials might use the present invention to reduce the hassle and cost of scheduling and being available for office visits from constituents. Non-profit organizations that cannot afford full office staffs during all business hours, might use the present invention to offer scheduled office hours to their patrons, reducing the hours of staffing needed each week.

Although the description above contains specificities, these should not be construed as limiting the scope of the invention, but as merely providing illustrations of some of the presently preferred embodiments of the invention. The scope of the invention should be determined by the appended claims and their legal equivalents, rather than by the examples given.

I claim:

1. A method for facilitating communication between a first party (“host”) and a second party (“guest”) over a communications network, said method comprising the steps:
A. Providing data about valuable information available, and terms by which said data may be made available, said data provided by a host;
B. Viewing said data and said terms by a guest;
C. Scheduling an interaction between said host and said guest;
D. Automatically initiating an interaction between said host and said guest when the time of said interaction is reached; and
E. Quantifying said interaction using a computer to store data regarding the quantified interaction, whereby the accounts may be settled between the guest and host.

2. A system for facilitating interaction between a host and guest over a communications network, said system comprising:
A. Database, including schedule data regarding, commerce data, and other descriptive data regarding each guest and host
B. First interface via which host provides data about valuable information that said first party may make available as well as terms (financial and schedule) on which said host will interact;
C. Second interface by which guest views data about valuable information that said first party may make available as well as terms (financial and schedule) on which said host will interact;
D. Third interface by which guest may view information regarding the pending or historical status of interaction with the host (or multiple hosts) and may view information regarding financial settlement with the host.
E. Fourth interface by which host may view information regarding the pending or historical status of interaction with the guest (or multiple guests) and may view information regarding financial settlement with the host.
F. A communications subsystem that automatically establishes a connection between said first party and said second party using said scheduling information.
G. A financial settlement subsystem that provides for quantification of the interaction between visitor and host for the purpose of conveniently settling the financial accounts among the host and guest.

3. The method as described in claim 1, wherein either the host or the guest includes one or more individuals

4. The method as described in claim 1, wherein the number of hosts and/or guests is a number greater than two individuals

5. The method as described in claim 1, wherein the communications network is a telephone system; a computer system; the Internet or the successors said telephone system, computer system or Internet.

6. The method as described in claim 1, wherein said valuable information includes entertainment, expertise, advice, counseling or any other information an individual may deem of value.

7. The method as described in claim 1, wherein said time of said scheduled interaction is immediate.

8. The method as described in claim 1, wherein said data includes, telephone rate information, call duration, call time-of-day, host preferences, guest preferences or any other information that may be useful in quantifying the interaction and settling accounts among the host and the guest.

9. The method as described in claim 1, further comprising: providing said valuable information by said host via a pre-recorded message.

10. The method as described in claim 1, wherein either the host or the guest is a computer program.
